(19) United States
(12) Patent Application Publication
(10) Pub. No.: US 2025/0297057 A1
(43) Pub. Date: Sep. 25, 2025

(54) LIQUID CRYSTALLINE POLYESTER, MOLDED ARTICLE, AND ELECTRIC/ELECTRONIC COMPONENT

(71) Applicant: ENEOS Materials Corporation, Tokyo (JP)

(72) Inventors: Hiroshi MATSUURA, Tokyo (JP); Juri ASADA, Tokyo (JP); Takashi SEKI, Tokyo (JP)

(73) Assignee: ENEOS Materials Corporation, Tokyo (JP)

(21) Appl. No.: 18/868,983

(22) PCT Filed: Mar. 30, 2023
(86) PCT No.: PCT/JP2023/013426

§ 371 Date: Nov. 25, 2024

(30) Foreign Application Priority Data
May 26, 2022 (JP) 2022-086114

(51) Int. Cl. C08G 63/06; C08G 63/60; C08G 63/664; C08G 63/682; C08J 5/18

(52) U.S. Cl. CPC C08G 63/065; C08G 63/605; C08G 63/664; C08G 63/6822; C08J 5/18; C08G 2250/00; C08J 2367/04; C08J 2367/06

(57) ABSTRACT

Provided is a liquid crystalline polyester that is excellent in dimensional stability while having a low dielectric loss tangent. The liquid crystalline polyester includes 90% by mol or more of a constitutional unit derived from an aromatic hydoxycarboxylic acid with respect to the amount of all constitutional units. In the liquid crystalline polyester, a dielectric loss tangent at a measurement frequency of 10 GHz is 1.0×10⁻³ or less, a difference (anisotropy) between mold shrinkage rates in the machine direction (MD) of the injection-molded piece of the liquid crystalline polyester and a transverse direction (TD) with respect to the machine direction is 1.00 or less, and a melt viscosity measured under conditions of a shear rate of 1000/s and the melting point of the liquid crystalline polyester to the melting point+20° C. is 25 Pa·s or more.

### BACKGROUND OF THE INVENTION

### Field of the Invention

The present invention relates to a liquid crystalline polyester, more specifically a liquid crystalline polyester having a low dielectric loss tangent, a molded article including the liquid crystalline polyester, and an electric/electronic component including the molded article.

### Background Art

In recent years, signals having frequencies in a high frequency band have been increasingly used in electronic instruments, communication instruments, and the like with increasing information communication traffic volumes in communication fields. In particular, signals having frequencies in a gigahertz (GHz) band in which the frequencies are 109 Hz or more have been heavily used. For example, high frequency bands in the GHz band have been used in an automotive field. Specifically, high frequencies of 76 to 79 GHz and 24 GHz have been used in millimeter wave and submillimeter wave radars mounted for the purpose of avoiding collisions of automobiles, respectively. Further widespread use of such radars is expected to proceed in the future.

However, the degradation of an output signal, which may cause the misrecognition of information, that is, a transmission loss is increased with increasing the frequency of a signal used. The transmission loss includes a conductor loss resulting from a conductor and a dielectric loss resulting from a resin for insulation, included in an electric/electronic component such as a substrate in an electronic instrument or a communication instrument. The conductor loss is proportional to the power of 0.5 of a frequency used, and the dielectric loss is proportional to the first power of the frequency. Therefore, the influence of the dielectric loss is very large in a high frequency band, particularly in a GHz band. Since the dielectric loss is also increased in proportion to the dielectric loss tangent of the resin, a resin having a low dielectric loss tangent is demanded to prevent the degradation of information.

Heat resistance, moldability, and the like are also demanded in a resin included in an electric/electronic component. For example, Patent Literature 1 proposes, as a polyester excellent in heat resistance and moldability, a wholly aromatic polyester including 40 to 75% by mol of a constitutional unit derived from 6-hydroxy-2-naphthoic acid, 8.5 to 30% by mol of a constitutional unit derived from terephthalic acid, 8.5 to 30% by mol of a constitutional unit derived from 4,4′-dihydroxybiphenyl, and 0.1 to 8% by mol of a constitutional unit derived from p-hydroxybenzoic acid at specific composition ratios.

### CITATION LIST

### Patent Literature

Patent Literature 1: Japanese Patent Laid-Open No. 2002-179776

### SUMMARY OF THE INVENTION

### Technical Problem

However, the present inventors found that a liquid crystalline polyester that is excellent in dimensional stability while having a sufficient low dielectric loss tangent is not obtained even when the wholly aromatic polyester proposed in Patent Literature 1 is used.

Thus, as a result of intensive examination for solving the problem described above, the present inventors found that a liquid crystalline polyester that is excellent in dimensional stability while having a low dielectric loss tangent is obtained by regulating specific properties (dielectric loss tangent, anisotropy, and melt viscosity) and the composition ratio of a specific constitutional unit in a liquid crystalline polyester including 90% by mol or more of a constitutional unit derived from an aromatic hydoxycarboxylic acid with respect to the amount of all the constitutional units.

Accordingly, an objective of the present invention is to provide a liquid crystalline polyester that is excellent in dimensional stability while having a low dielectric loss tangent. Moreover, another object of the present invention is to provide a molded article including the liquid crystalline polyester and an electric/electronic component including the molded article.

### Solution to Problem

In other words, in accordance with the present invention, the following inventions are provided.

[1] A liquid crystalline polyester including 90% by mol or more of a constitutional unit derived from an aromatic hydoxycarboxylic acid with respect to an amount of all constitutional units, wherein
a dielectric loss tangent at a measurement frequency of 10 GHz is 1.0×10⁻³ or less,
a difference (anisotropy) between mold shrinkage rates in a machine direction (MD) of an injection-molded piece of the liquid crystalline polyester and a transverse direction (TD) with respect to the machine direction is 1.00 or less, and
a melt viscosity measured under conditions of a shear rate of 1000/s and a melting point of the liquid crystalline polyester to the melting point+20° C. is 25 Pa·s or more.

[2] A liquid crystalline polyester including 90% by mol or more of a constitutional unit derived from an aromatic hydoxycarboxylic acid with respect to an amount of all constitutional units, wherein
the liquid crystalline polyester includes a constitutional unit (A) derived from p-hydroxybenzoic acid, a constitutional unit (B) derived from 6-hydroxy-2-naphthoic acid, and a constitutional united (C) derived from a hydroxycarboxylic acid, other than the constitutional units (A) and (B), and
composition ratios (% by mol) of the constitutional units (A) to (C) satisfy following conditions:
10% by mol≤constitutional unit (A)≤35% by mol,
50% by mol≤constitutional unit (B)≤85% by mol, and
0.01% by mol≤constitutional unit (C)<15% by mol.

[3] The liquid crystalline polyester according to [2], wherein the constitutional unit (C) is a constitutional unit derived from at least one selected from a group consisting of 4′-hydroxy-4-biphenylcarboxylic acid, 6-hydroxynicotinic acid, m-hydroxybenzoic acid, 4-hydroxy-3-methylbenzoic acid, 2-fluoro-4-hydroxybenzoic acid, 4-acetamidebenzoic acid, 4-(4-hydroxyphenoxy)benzoic acid, and coumaric acid.

[4] The liquid crystalline polyester according to [2], wherein the constitutional unit (C) is a constitutional unit derived from at least one selected from a group consisting of 4′-hydroxy-4-biphenylcarboxylic acid, 6-hydroxynicotinic acid, and m-hydroxybenzoic acid.

[5] The liquid crystalline polyester according to any of [2] to [4], further including at least one kind selected from a group consisting of a constitutional unit (D) derived from an aromatic diol and a constitutional unit (E) derived from an aromatic dicarboxylic acid.

[6] The liquid crystalline polyester according to any of [1] to [5], wherein the liquid crystalline polyester has a melting point of 280° C. or more.

[7] The liquid crystalline polyester according to any of [1] to [6], wherein a temperature difference between a melting point and a crystallization point is 30° C. or more.

[8] A fibrous molded article including the liquid crystalline polyester according to any of [1] to [7].

[9] A sheet-like molded article including the liquid crystalline polyester according to any of [1] to [7].

[10] An injection-molded article including the liquid crystalline polyester according to any of [1] to [7].

[11] An electric/electronic component including the molded article according to [8].

[12] An electric/electronic component including the molded article according to [9].

[13] An electric/electronic component including the molded article according to [10].

### Advantageous Effects of Invention

In accordance with the present invention, a liquid crystalline polyester that is excellent in dimensional stability while having a low dielectric loss tangent can be realized. The dimensional stability of a produced molded article can be improved by using the liquid crystalline polyester of the present invention. Accordingly, the degradation of the quality of an output signal in an electric/electronic instrument or a communication instrument using a signal having a high frequency when the resin is process-molded and used for a product.

### DESCRIPTION OF EMBODIMENTS

### (Liquid Crystalline Polyester)

A liquid crystalline polyester according to the present invention includes 90% by mol or more of a constitutional unit derived from an aromatic hydoxycarboxylic acid with respect to all the constitutional units. In the present invention, the liquid crystalline polyester that is excellent in dimensional stability while having a low dielectric loss tangent can be obtained by satisfying the configurations of the following first and/or second embodiments.

### First Embodiment

In a first embodiment of the present invention, the liquid crystalline polyester has the following specific properties (dielectric loss tangent, anisotropy, and melt viscosity).

The upper limit value of the dielectric loss tangent of the liquid crystalline polyester according to the present invention at a measurement frequency of 10 GHz is 1.0×10⁻³ or less, preferably 0.95×10⁻³ or less, more preferably 0.90×10⁻³ or less, and still more preferably 0.85×10⁻³ or less. Since a molded article having a low dielectric loss tangent can be produced by setting the dielectric loss tangent of the liquid crystalline polyester according to the present invention in the numerical range described above, the degradation of the quality of an output signal in an electric/electronic instrument or a communication instrument using a signal having a high frequency when the resin is used for a product can be prevented.

Herein, the dielectric loss tangent of the liquid crystalline polyester at 10 GHz can be measured by a split post dielectric resonator method (SPDR method) using Network Analyzer N5247A from Keysight Technologies, or the like.

The upper limit value of the absolute value of a difference (anisotropy) between mold shrinkage rates in the machine direction (MD) of the injection-molded piece of the liquid crystalline polyester according to the present invention and the transverse direction (TD) with respect to the machine direction is 1.00 or less, preferably 0.99 or less, and more preferably 0.98 or less. By setting the anisotropy of the liquid crystalline polyester according to the present invention in the numerical range described above, the dimensional stability of a molded article produced using the liquid crystalline polyester can be improved.

Herein, the anisotropy of the liquid crystalline polyester is a difference between mold shrinkage rates (mold shrinkage rate in TD-mold shrinkage rate in MD) calculated from the measurement results of the mold shrinkage rates (%) of a flat-plate-shaped test piece of 50 mm×50 mm×1 mm, obtained by heating the liquid crystalline polyester to melt at a melting point to the melting point+20° C., in MD and TD.

The lower limit value of melt viscosity measured under conditions of the melting point of the liquid crystalline polyester according to the present invention to the melting point+20° C. and a shear rate (1000/s) is 25 Pas or more, preferably 30 Pas or more, and more preferably 35 Pa·s or more, still more preferably 40 Pas or more, and even more preferably 45 Pa·s or more. Moreover, the upper limit value thereof is preferably 1000 Pas or less, more preferably 700 Pas or less, and still more preferably 250 Pas or less. By setting the melt viscosity of the liquid crystalline polyester according to the present invention in the numerical range described above, a dielectric loss tangent can be allowed to be lower, and the mechanical strength of a molded article can be further improved.

Herein, the viscosity of the liquid crystalline polyester can be measured using a capillary rheometer viscometer according to JIS K7199.

### Second Embodiment

In a second embodiment of the present invention, a liquid crystalline polyester includes a constitutional unit (A) derived from p-hydroxybenzoic acid, a constitutional unit (B) derived from 6-hydroxy-2-naphthoic acid, and a constitutional united (C) derived from a hydroxycarboxylic acid, other than the constitutional units (A) and (B), and
the composition ratios (% by mol) of the constitutional units (A) to (C) satisfy the following conditions:
10% by mol≤constitutional unit (A)≤35% by mol,
50% by mol≤constitutional unit (B)≤85% by mol, and
0.01% by mol≤constitutional unit (C)<15% by mol.

In the liquid crystalline polyester according to the present invention, the composition ratios (% by mol) of the constitutional units (A) to (C) preferably satisfy the following conditions:
15% by mol≤constitutional unit (A)≤33% by mol,
55% by mol≤ constitutional unit (B)≤84% by mol, and
0.05% by mol≤constitutional unit (C)≤13% by mol,
more preferably satisfy
18% by mol≤ constitutional unit (A)≤30% by mol,
60% by mol≤constitutional unit (B)≤81% by mol, and
0.1% by mol≤constitutional unit (C)≤10% by mol,
still more preferably satisfy
19% by mol≤constitutional unit (A)≤29% by mol,
63% by mol≤constitutional unit (B)≤80% by mol, and
0.5% by mol≤constitutional unit (C)≤9% by mol, and
particularly preferably satisfy
20% by mol≤constitutional unit (A)≤28% by mol,
65% by mol≤constitutional unit (B)≤78% by mol, and
1% by mol≤constitutional unit (C)≤8% by mol.

Moreover, when the liquid crystalline polyester according to the present invention includes constitutional units (D) and (E) described later as well as the constitutional units (A) to (C), the composition ratios (% by mol) of the constitutional units (A) to (E) preferably satisfy the following conditions:
15% by mol≤constitutional unit (A)≤33% by mol,
55% by mol≤constitutional unit (B)≤84% by mol,
0.05% by mol≤constitutional unit (C)≤13% by mol, and
0.01≤[constitutional unit (D)+constitutional unit (E)]≤3% by mol,
more preferably satisfy
18% by mol≤constitutional unit (A)≤30% by mol,
60% by mol≤constitutional unit (B)≤81% by mol,
0.1% by mol≤constitutional unit (C)≤10% by mol, and
0.01≤[constitutional unit (D)+constitutional unit (E)]≤3% by mol,
still more preferably satisfy
19% by mol≤constitutional unit (A)≤29% by mol,
63% by mol≤constitutional unit (B)≤80% by mol,
0.5% by mol≤constitutional unit (C)≤9% by mol, and
0.05% by mol≤[constitutional unit (D)+constitutional unit (E)]≤2% by mol, and
particularly preferably satisfy
20% by mol≤constitutional unit (A)≤28% by mol,
65% by mol≤constitutional unit (B)≤78% by mol,
1% by mol≤constitutional unit (C)≤8% by mol, and
0.1% by mol≤[constitutional unit (D)+constitutional unit (E)]≤ 1% by mol.

Moreover, the liquid crystalline polyester of the second embodiment preferably has the specific properties (dielectric loss tangent, melting point, anisotropy, and melt viscosity) described in the first embodiment.

Further, the liquid crystalline polyesters of the first and second embodiments preferably have the following specific properties (melting point, and temperature difference between melting point and crystallization point).

The lower limit value of the melting point of the liquid crystalline polyester according to the present invention is not particularly restricted. In consideration of heat resistance, it is commonly demanded that the melting point is 250° C. or more. The lower limit value thereof is preferably 280° C. or more, more preferably 290° C. or more, still more preferably 300° C. or more, and even more preferably 305° C. or more, and the upper limit value thereof is preferably 340° C. or less, more preferably 335° C. or less, and still more preferably 330° C. or less. Heat resistance to heating processing of a molded article produced using the liquid crystalline polyester can be improved by setting the melting point of the liquid crystalline polyester according to the present invention in the numerical range described above.

The lower limit value of the crystallization point of the liquid crystalline polyester according to the present invention is preferably 230° C. or more, more preferably 235° C. or more, still more preferably 240° C. or more, and even more preferably 245° C. or more, and the upper limit value thereof is preferably 300° C. or less, more preferably 295° C. or less, still more preferably 290° C. or less, and even more preferably 285° C. or less.

The lower limit value of a temperature difference between the melting point and crystallization point of the liquid crystalline polyester according to the present invention (=“melting point (° C.)”−“crystallization point (° C.)”) is preferably 30° C. or more, more preferably 35° C. or more, and still more preferably 40° C. or more, and the upper limit value thereof is preferably 70° C. or less, more preferably 65° C. or less, and still more preferably 60° C. or less. By setting the temperature difference between the melting point and crystallization point of the liquid crystalline polyester according to the present invention in the numerical range described above, sufficient time between melting and solidification of liquid crystalline polyester can be spent in the case of melting and molding the liquid crystalline polyester, and the degree of freedom of setting of a temperature condition such as a melting and molding temperature can be enhanced.

Herein, the melting point and crystallization point of the liquid crystalline polyester are values measured by a differential scanning calorimeter (DSC). Specifically, the vertex of an exothermic peak obtained when the temperature of the liquid crystalline polyester is increased from room temperature to 340 to 360° C. at a temperature-raising rate of 10° C./min to completely melt the liquid crystalline polyester, and the temperature is then decreased to 30° C. at a rate of 10° C./min is regarded as the crystallization point (Tc), and the vertex of an endothermic peak obtained when the temperature is further raised to 360° C. at a rate of 10° C./min is regarded as a melting point (Tm).

The liquid crystal property of the liquid crystalline polyester according to the present invention can be confirmed by observing the presence or absence of optical anisotropy after heating of the liquid crystalline polyester to melt on a microscope heating stage by using a polarizing microscope (trade name: BH-2) that includes a hot stage for a microscope (trade name: FP82HT), manufactured by METTLER TOLEDO, and is manufactured by Olympus Corporation, or the like.

Each constitutional unit included in the liquid crystalline polyester according to the present invention is described in detail below.

(Constitutional Unit (A) Derived from Aromatic Hydoxycarboxylic Acid)

The constitutional unit (A) derived from an aromatic hydoxycarboxylic acid is a constitutional unit derived from p-hydroxybenzoic acid (HBA). Examples of monomers providing the constitutional unit (A) include p-hydroxybenzoic acid, and acetylides, ester derivatives, and acid halides thereof.

The composition ratio (% by mol) of the constitutional unit (A) in the liquid crystalline polyester is preferably 10% by mol or more and 30% by mol or less. The lower limit value of the composition ratio (% by mol) of the constitutional unit (A) is preferably 15% by mol or more, more preferably 18% by mol or more, still more preferably 19% by mol or more, and even more preferably 20% by mol or more, and the upper limit value thereof is preferably 33% by mol or less, more preferably 30% by mol or less, still more preferably 29% by mol or less, and even more preferably 28% by mol or less from the viewpoint of the degradation of the dielectric loss tangent of the liquid crystalline polyester, improvement in dimensional stability, and the like.

(Constitutional Unit (B) Derived from Aromatic Hydoxycarboxylic Acid)

The constitutional unit (B) derived from an aromatic hydoxycarboxylic acid is a constitutional unit derived from 6-hydroxy-2-naphthoic acid (HNA). Examples of a monomer providing the constitutional unit (B) include 6-hydroxy-2-naphthoic acid, and acetylides, ester derivatives, and acid halides thereof.

The composition ratio (% by mol) of the constitutional unit (B) in the liquid crystalline polyester is preferably 50% by mol or more and 85% by mol or less. The lower limit value of the composition ratio (% by mol) of the constitutional unit (B) is preferably 55% by mol or more, more preferably 60% by mol or more, still more preferably 63% by mol or more, and even more preferably 65% by mol or more, and the upper limit value thereof is preferably 84% by mol or less, more preferably 81% by mol or less, still more preferably 80% by mol or less, and even more preferably 78% by mol or less from the viewpoint of the degradation of the dielectric loss tangent of the liquid crystalline polyester, improvement in dimensional stability, and the like.

(Constitutional Unit (C) Derived from Aromatic Hydoxycarboxylic Acid)

The constitutional unit (C) derived from an aromatic hydoxycarboxylic acid is not particularly limited as long as the constitutional unit (C) is a constitutional unit derived from a hydroxycarboxylic acid, other than the constitutional units (A) and (B). The constitutional unit (C) is preferably a constitutional unit derived from at least one selected from the group consisting of, for example, 4′-hydroxy-4-biphenylcarboxylic acid, 6-hydroxynicotinic acid, m-hydroxybenzoic acid, 4-hydroxy-3-methylbenzoic acid, 2-fluoro-4-hydroxybenzoic acid, 4-acetamidebenzoic acid, 4-(4-hydroxyphenoxy)benzoic acid, and coumaric acid. Of these, 4′-hydroxy-4-biphenylcarboxylic acid, 6-hydroxynicotinic acid, and m-hydroxybenzoic acid are more preferred. Examples of a monomer providing the constitutional unit (C) include these monomers, and acetylides, ester derivatives, and acid halides thereof.

The composition ratio (% by mol) of the constitutional unit (C) in the liquid crystalline polyester is preferably 0.01% by mol or more and less than 15% by mol. The lower limit value of the composition ratio (% by mol) of the constitutional unit (C) is preferably 0.05% by mol or more, more preferably 0.1% by mol or more, still more preferably 0.5% by mol or more, and even more preferably 1% by mol or more, and the upper limit value thereof is preferably 13% by mol or less, more preferably 10% by mol or less, still more preferably 9% by mol or less, and even more preferably 8% by mol or less from the viewpoint of a decrease in the dielectric loss tangent of the liquid crystalline polyester, improvement in dimensional stability, and the like.

(Constitutional Unit (D) Derived from Aromatic Diol)

The liquid crystalline polyester according to the present invention may further include the constitutional unit (D) derived from an aromatic diol. The constitutional unit (D) derived from an aromatic diol is preferably a constitutional unit derived from an aromatic diol represented by the following Formula (1). Only one kind of such a constitutional unit (D) may be included, or two or more kinds of such constitutional units (D) may be included.

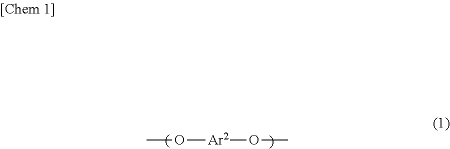

Ar² in Formula as described above is a divalent hydrocarbon group having an aromatic ring, which divalent hydrocarbon group may have a substituent as desired. Examples of such a hydrocarbon group having an aromatic ring include a phenyl group, a biphenyl group, a 4,4′-isopropylidenediphenyl group, a naphthyl group, an anthryl group, and a phenanthryl group. Examples of the substituent include hydrogen, an alkyl group, an alkoxy group, and fluorine. The number of carbon atoms included in the alkyl group is preferably 1 to 10, and more preferably 1 to 5. The alkyl group may be a straight-chain alkyl group or may be a branched-chain alkyl group. The number of carbon atoms included in the alkoxy group is preferably 1 to 10, and more preferably 1 to 5.

Examples of a monomer providing the constitutional unit (D) include 4,4-dihydroxybiphenyl (BP), hydroquinone (HQ), methylhydroquinone (MeHQ), 4,4′-isopropylidenediphenol (BisPA), and acylated products, ester derivatives, and acid halides thereof.

(Constitutional Unit (E) Derived from Aromatic Dicarboxylic Acid)

The liquid crystalline polyester according to the present invention may further include the constitutional unit (E) derived from an aromatic dicarboxylic acid. The liquid crystalline polyester may further include the constitutional unit (D) derived from an aromatic diol. The constitutional unit (E) derived from an aromatic dicarboxylic acid is preferably a constitutional unit derived from an aromatic dicarboxylic acid represented by the following Formula (2). Only one kind of such a constitutional unit (E) may be included, or two or more kinds of such constitutional units (E) may be included.

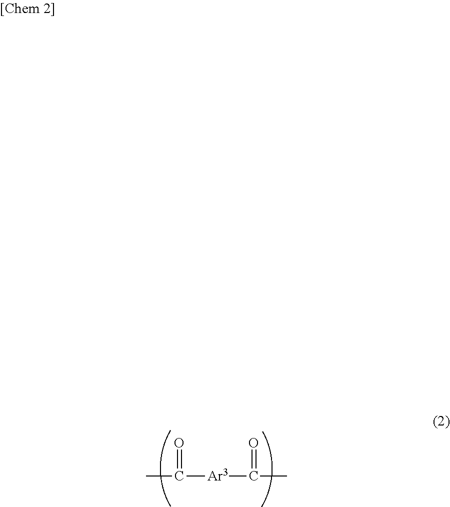

Ar³ in Formula as described above is a divalent hydrocarbon group with an aromatic ring, which divalent hydrocarbon group may have a substituent as desired. Examples of such a hydrocarbon group having an aromatic ring include a phenyl group, a biphenyl group, a 4,4′-isopropylidenediphenyl group, a naphthyl group, an anthryl group, and a phenanthryl group. Examples of the substituent include hydrogen, an alkyl group, an alkoxy group, and fluorine. The number of carbon atoms included in the alkyl group is preferably 1 to 10, and more preferably 1 to 5. The alkyl group may be a straight-chain alkyl group or may be a branched-chain alkyl group. The number of carbon atoms included in the alkoxy group is preferably 1 to 10, and more preferably 1 to 5.

Examples of a monomer providing the constitutional unit (E) include terephthalic acid (TPA), isophthalic acid (IPA), 2,6-naphthalene dicarboxylic acid (NADA), and acylated products, ester derivatives, and acid halides thereof.

The total composition ratio (% by mol) of the constitutional unit (D) and the constitutional unit (E) in the liquid crystalline polyester is preferably 0.01% by mol or more and 3% by mol or less. The lower limit value of the total composition ratio (% by mol) of the constitutional unit (D) and the constitutional unit (E) is preferably 0.05% by mol or more, and more preferably 0.1% by mol or more, and the upper limit value thereof is preferably 2% by mol or less, and more preferably 1% by mol or less from the viewpoint of a decrease in the dielectric loss tangent of the liquid crystalline polyester, improvement in dimensional stability, and the like.

### (Method of Producing Liquid Crystalline Polyester)

The liquid crystalline polyester according to the present invention can be produced by a method (two-stage polymerization) including: a step of performing melt polymerization of a monomer providing constitutional units (A) to (C) and, optionally, at least one of a monomer providing a constitutional unit (D) and a monomer providing a constitutional unit (E) to obtain a polymer; and a step of performing solid phase polymerization of the polymer to obtain a liquid crystalline polyester.

The melt polymerization is preferably performed under reflux of acetic acid in the presence of 1.03 to 1.15 molar equivalent of acetic anhydride with respect to all the hydroxyl groups included in all the monomers from the viewpoint of efficiently obtaining the liquid crystalline polyester.

A reaction temperature in the melt polymerization is preferably in a temperature range of a melting point to (melting point+70)° C., and more preferably a temperature range of (melting point+20)° C. to (melting point+50° C.)

The melt polymerization is preferably performed in the presence of a catalyst and in the absence of a solvent. A conventionally known catalyst for polymerization of a polymer can be used as the catalyst. Examples of the catalyst include metal salt catalysts such as potassium acetate, magnesium acetate, tin (II) acetate, lead acetate, sodium acetate, tetrabutyl titanate, and antimony trioxide, and organic compound catalysts such as nitrogen-containing heterocyclic compounds such as N-methylimidazole. The amount of the catalyst used is not particularly limited, and is preferably the total number of moles of monomers×(10 to 100) mg/mol.

When the solid phase polymerization is performed, the polymer obtained by the melt polymerization may be cooled and solidified, and then pulverized to allow the polymer to be in powder or flaky form. A polymer strand obtained by the melt polymerization may also be pelletized to be in pellet form. A reaction temperature in the solid phase polymerization is preferably a melting point or less, and preferably (melting point−30° C.) to (melting point−10° C.) The solid phase polymerization may be performed while stirring, or may be performed in a standing state without stirring.

A polymerization reaction apparatus is not particularly limited, and general reaction apparatuses that are used in reaction of high viscosity fluid are preferably used. Examples of these reaction apparatuses include: stirred tank type polymerization reaction apparatuses including stirring apparatuses including stirring blades having, for example, anchor shapes, multistage shapes, helical belt shapes, screw axis shapes, and the like, and various shapes formed by deforming the shapes; and mixing apparatuses that are commonly used for kneading resin, such as kneaders, roll mills, and Banbury mixers.

### (Molded Article)

A molded article according to the present invention includes the liquid crystalline polyester and may further include a filler.

### (Filler)

Examples of the filler include carbonaceous fibers (carbon fibers), graphite, glass fibers, talc, mica, glass flakes, clay, sericite, calcium carbonate, calcium sulfate, calcium silicate, silica, alumina, aluminum hydroxide, calcium hydroxide, graphite, potassium titanate, titanium oxide, fluorocarbon resin fibers, fluorocarbon resin, barium sulfate, and various whiskers. One of such fillers may be used singly, or two or more of such fillers may be used.

The content of the filler in the molded article is preferably 1% by mass or more and 70% by mass or less, more preferably 5% by mass or more and 60% by mass or less, still more preferably 10% by mass or more and 50% by mass or less, and even more preferably 15% by mass or more and 45% by mass or less with respect to the total amount of the molded article. When two or more fillers are included, the total content thereof is preferably in the range described above. The above-described range of the content of the filler in the molded article allows a molded article superior in mechanical characteristics to be obtained, and is therefore preferred.

### (Additional Resin)

The molded article according to the present invention may include an additional resin other than the liquid crystalline polyester without departing from the gist of the present invention. Examples of such an additional resin include: polyesters such as polyethylene terephthalate, polyethylene naphthalate, polyarylate, polycyclohexylene dimethylene terephthalate, and polybutylene terephthalate; polyolefin resins such as polyethylene and polypropylene; vinyl resins such as cycloolefin polymers and polyvinyl chloride; (meth)acryl resins such as polyacrylate, polymethacrylate, and polymethyl methacrylate; polyphenylene ether resins; polyacetal resins; polyamide resins; imide resins such as polyimide and polyetherimide; polystyrene resins such as polystyrene, high impact polystyrene, AS resin, and ABS resin; thermoset resins such as epoxy resin; cellulosic resin; polyether ether ketone resin; fluorine resin; and polycarbonate resin. One of such additional resins may be used singly, or two or more of such fillers may be used.

The upper limit value of the content of the additional resin other than the liquid crystalline polyester in the molded article is preferably 10 parts by mass or less, and more preferably 5 parts by mass or less with respect to 100 parts by mass of the liquid crystalline polyester.

### (Additional Additive)

The molded article according to the present invention may include an additional additive, for example, a coloring agent, a dispersant, a plasticizer, an antioxidant, a curing agent, a flame retardant, a heat stabilizer, an ultraviolet absorbent, an antistatic agent, and a surfactant without departing from the gist of the present invention. One of such additional additives may be used singly, or two or more of such additional additives may be used.

The shape of the molded article is changed depending on an application as appropriate, and is not particularly limited. Examples of the shape of the molded article include fibrous shapes, plate shapes, sheet shapes, and rod shapes.

The molded article according to the present invention can be produced by a conventionally known molding method using a resin composition including a liquid crystalline polyester, and optionally a filler, an additional resin, and the like. The molding method may be any of methods such as, for example, a melt spinning method, a solution spinning method, an injection molding method, a compression molding method, an injection compression molding method, calender molding, stamping molding.

### (Electric/Electronic Component)

An electric/electronic component according to the present invention includes a molded article (for example, a fibrous molded article, an injection-molded article, or the like) including the liquid crystalline polyester. Examples of the electric/electronic component including the molded article described above include: antennas used in electronic instruments and communication instruments such as ETC, the GPS, wireless LANs, and cell phones; connectors for high speed transmission; CPU sockets; circuit boards; flexible printed circuit boards (FPC); circuit boards for lamination; millimeter wave and submillimeter wave radars such as radars for collision avoidance; RFID tags; capacitors; inverter components; covering materials for cables; insulating materials for secondary batteries such as lithium-ion batteries; and speaker vibrating plates.

### EXAMPLES

The present invention is more specifically described with reference to Examples. However, the present invention is not limited to Examples.

### Production of Liquid Crystalline Polyester

### Example 1

Into a polymerization container including a stirring blade, 25% by mol of p-hydroxybenzoic acid (HBA), 73% by mol of 6-hydroxy-2-naphthoic acid (HNA), and 2% by mol of 4′-hydroxy-4-biphenylcarboxylic acid (C1) were added, potassium acetate was loaded as a catalyst, depressurization and injection with nitrogen in the polymerization container were performed three times, thereafter, acetic anhydride (1.05 mol equivalent with respect to a hydroxyl group) was further added, a temperature was raised to 150° C., and acetylation reaction was performed in a reflux state for 2 hours.

After the acetylation, the polymerization container allowed to be in the state of distilling acetic acid, and the temperature of the molten zone in the tank was raised to a temperature of 310° C. at 0.5° C./min. Then, a polymer was extracted, and cooled to solidify. The obtained polymer was pulverized to have a size allowing the polymer to pass through a sieve having an opening of 2.0 mm to obtain a polymer. Then, the temperature of the obtained polymer was raised from room temperature to 300° C. by an oven heater manufactured by Yamato Scientific Co., Ltd., followed by keeping the polymer for 2 hours to perform solid phase polymerization.

Then, natural heat dissipation of the polymer at room temperature was performed to obtain the polyester of the present invention. The liquid crystal properties of the polyester were confirmed based on the presence or absence of optical anisotropy after heating of the polyester to melt on a microscope heating stage by using a polarizing microscope (trade name: BH-2) that included a hot stage for a microscope (trade name: FP82HT), manufactured by METTLER TOLEDO, and was manufactured by Olympus Corporation.

### Example 2

A polyester was obtained in a manner similar to that in Example 1 except that loaded monomers were changed to 25% by mol of HBA, 73% by mol of HNA, 1% by mol of 4′-hydroxy-4-biphenylcarboxylic acid (C1), and 1% by mol of 6-hydroxynicotinic acid (C2). Then, the liquid crystal properties of the polyester were confirmed in a manner similar to the above-described manner.

### Example 3

A polyester was obtained in a manner similar to that in Example 1 except that loaded monomers were changed to 22% by mol of HBA, 73% by mol of HNA, and 5% by mol of 4′-hydroxy-4-biphenylcarboxylic acid (C1). Then, the liquid crystal properties of the polyester were confirmed in a manner similar to the above-described manner.

### Example 4

A polyester was obtained in a manner similar to that in Example 1 except that loaded monomers were changed to 25% by mol of HBA, 73% by mol of HNA, and 2% by mol of 4-hydroxy-3-methylbenzoic acid (C3). Then, the liquid crystal properties of the polyester were confirmed in a manner similar to the above-described manner.

### Example 5

A polyester was obtained in a manner similar to that in Example 1 except that loaded monomers were changed to 25% by mol of HBA, 73% by mol of HNA, and 2% by mol of 2-fluoro-4-hydroxybenzoic acid (C4). Then, the liquid crystal properties of the polyester were confirmed in a manner similar to the above-described manner.

### Example 6

A polyester was obtained in a manner similar to that in Example 1 except that loaded monomers were changed to 28% by mol of HBA, 69% by mol of HNA, 2% by mol of 4′-hydroxy-4-biphenylcarboxylic acid (C1), and 1% by mol of m-hydroxybenzoic acid (C5). Then, the liquid crystal properties of the polyester were confirmed in a manner similar to the above-described manner.

### Example 7

A polyester was obtained in a manner similar to that in Example 1 except that loaded monomers were changed to 25% by mol of HBA, 73% by mol of HNA, and 2% by mol of 4-(4-hydroxyphenoxy)benzoic acid (C6). Then, the liquid crystal properties of the polyester were confirmed in a manner similar to the above-described manner.

### Example 8

A polyester was obtained in a manner similar to that in Example 1 except that loaded monomers were changed to 19% by mol of HBA, 73% by mol of HNA, and 8% by mol of 4′-hydroxy-4-biphenylcarboxylic acid (C1). Then, the liquid crystal properties of the polyester were confirmed in a manner similar to the above-described manner.

### Example 9

A polyester was obtained in a manner similar to that in Example 1 except that loaded monomers were changed to 26.5% by mol of HBA, 73% by mol of HNA, and 0.5% by mol of 4′-hydroxy-4-biphenylcarboxylic acid (C1). Then, the liquid crystal properties of the polyester were confirmed in a manner similar to the above-described manner.

### Example 10

A polyester was obtained in a manner similar to that in Example 1 except that loaded monomers were changed to 25% by mol of HBA, 73% by mol of HNA, and 2% by mol of coumaric acid (C7). Then, the liquid crystal properties of the polyester were confirmed in a manner similar to the above-described manner.

### Example 11

A polyester was obtained in a manner similar to that in Example 1 except that loaded monomers were changed to 24.9% by mol of HBA, 72.6% by mol of HNA, 2% by mol of 4′-hydroxy-4-biphenylcarboxylic acid (C1), and 0.5% by mol of terephthalic acid (TPA). Then, the liquid crystal properties of the polyester were confirmed in a manner similar to the above-described manner.

### Example 12

A polyester was obtained in a manner similar to that in Example 1 except that loaded monomers were changed to 24.9% by mol of HBA, 72.6% by mol of HNA, 2% by mol of 6-hydroxynicotinic acid (C2), and 0.5% by mol of TPA. Then, the liquid crystal properties of the polyester were confirmed in a manner similar to the above-described manner.

### Example 13

A polyester was obtained in a manner similar to that in Example 1 except that loaded monomers were changed to 25% by mol of HBA, 73% by mol of HNA, and 2% by mol of m-hydroxybenzoic acid (C5). Then, the liquid crystal properties of the polyester were confirmed in a manner similar to the above-described manner.

### Example 14

A polyester was obtained in a manner similar to that in Example 1 except that loaded monomers were changed to 19% by mol of HBA, 73% by mol of HNA, and 8% by mol of 6-hydroxynicotinic acid (C2). Then, the liquid crystal properties of the polyester were confirmed in a manner similar to the above-described manner.

### Comparative Example 1

A polyester was obtained in a manner similar to that in Example 1 except that loaded monomers were changed to 73% by mol of HBA and 27% by mol of HNA. Then, the liquid crystal properties of the polyester were confirmed in a manner similar to the above-described manner.

### Comparative Example 2

A polyester was obtained in a manner similar to that in Example 1 except that loaded monomers were changed to 60% by mol of HBA, 20% by mol of 4,4′-dihydroxybiphenyl (BP), 15% by mol of TPA, and 5% by mol of isophthalic acid (IPA). Then, the liquid crystal properties of the polyester were confirmed in a manner similar to the above-described manner.

### Comparative Example 3

A polyester was obtained in a manner similar to that in Example 1 except that loaded monomers were changed to 6% by mol of HBA, 40% by mol of HNA, 27% by mol of BP, and 27% by mol of 2,6-naphthalene dicarboxylic acid (NADA). Then, the liquid crystal properties of the polyester were confirmed in a manner similar to the above-described manner.

### Comparative Example 4

A polyester was obtained in a manner similar to that in Example 1 except that loaded monomers were changed to 35% by mol of HBA, 50% by mol of HNA, and 15% by mol of 4-acetamidebenzoic acid (C8). Then, the liquid crystal properties of the polyester were confirmed in a manner similar to the above-described manner.

### Comparative Example 5

A polyester was obtained in a manner similar to that in Example 1 except that loaded monomers were changed to 20% by mol of HBA, 73% by mol of HNA, and 7% by mol of m-hydroxybenzoic acid (C5). Then, the liquid crystal properties of the polyester were confirmed in a manner similar to the above-described manner.

### Example 15

A polyester was obtained in a manner similar to that in Example 1 except that loaded monomers were changed to 28.9% by mol of HBA, 68.6% by mol of HNA, 2% by mol of 6-hydroxynicotinic acid (C2), and 0.5% by mol of IPA. Then, the liquid crystal properties of the polyester were confirmed in a manner similar to the above-described manner.

### Example 16

A polyester was obtained in a manner similar to that in Example 1 except that loaded monomers were changed to 25.9% by mol of HBA, 69.6% by mol of HNA, 4% by mol of 6-hydroxynicotinic acid (C2), and 0.5% by mol of IPA. Then, the liquid crystal properties of the polyester were confirmed in a manner similar to the above-described manner.

### Example 17

A polyester was obtained in a manner similar to that in Example 1 except that loaded monomers were changed to 24.9% by mol of HBA, 72.6% by mol of HNA, 2% by mol of 6-hydroxynicotinic acid (C2), and 0.5% by mol of IPA. Then, the liquid crystal properties of the polyester were confirmed in a manner similar to the above-described manner.

### Example 18

A polyester was obtained in a manner similar to that in Example 1 except that loaded monomers were changed to 24.9% by mol of HBA, 72.6% by mol of HNA, 2% by mol of m-hydroxybenzoic acid (C5), and 0.5% by mol of TPA. Then, the liquid crystal properties of the polyester were confirmed in a manner similar to the above-described manner.

### Example 19

A polyester was obtained in a manner similar to that in Example 1 except that loaded monomers were changed to 29.9% by mol of HBA, 68.6% by mol of HNA, 1% by mol of m-hydroxybenzoic acid (C5), and 0.5% by mol of TPA. Then, the liquid crystal properties of the polyester were confirmed in a manner similar to the above-described manner.

### Example 20

A polyester was obtained in a manner similar to that in Example 1 except that loaded monomers were changed to 11.9% by mol of HBA, 79.6% by mol of HNA, 8% by mol of m-hydroxybenzoic acid (C5), and 0.5% by mol of TPA. Then, the liquid crystal properties of the polyester were confirmed in a manner similar to the above-described manner.

### Example 21

A polyester was obtained in a manner similar to that in Example 1 except that loaded monomers were changed to 24.9% by mol of HBA, 68.6% by mol of HNA, 6% by mol of m-hydroxybenzoic acid (C5), and 0.5% by mol of TPA. Then, the liquid crystal properties of the polyester were confirmed in a manner similar to the above-described manner.

### Example 22

A polyester was obtained in a manner similar to that in Example 1 except that loaded monomers were changed to 16.9% by mol of HBA, 74.6% by mol of HNA, 8% by mol of m-hydroxybenzoic acid (C5), and 0.5% by mol of TPA. Then, the liquid crystal properties of the polyester were confirmed in a manner similar to the above-described manner.

### Example 23

A polyester was obtained in a manner similar to that in Example 1 except that loaded monomers were changed to 19.9% by mol of HBA, 74.6% by mol of HNA, 5% by mol of m-hydroxybenzoic acid (C5), and 0.5% by mol of TPA. Then, the liquid crystal properties of the polyester were confirmed in a manner similar to the above-described manner.

### Example 24

A polyester was obtained in a manner similar to that in Example 1 except that loaded monomers were changed to 22.9% by mol of HBA, 71.6% by mol of HNA, 5% by mol of m-hydroxybenzoic acid (C5), and 0.5% by mol of TPA. Then, the liquid crystal properties of the polyester were confirmed in a manner similar to the above-described manner.

### Example 25

A polyester was obtained in a manner similar to that in Example 1 except that loaded monomers were changed to 34% by mol of HBA, 65% by mol of HNA, and 1% by mol of m-hydroxybenzoic acid (C5). Then, the liquid crystal properties of the polyester were confirmed in a manner similar to the above-described manner.

### Example 26

A polyester was obtained in a manner similar to that in Example 1 except that loaded monomers were changed to 24.9% by mol of HBA, 72.6% by mol of HNA, 2% by mol of m-hydroxybenzoic acid (C5), and 0.5% by mol of BP. Then, the liquid crystal properties of the polyester were confirmed in a manner similar to the above-described manner.

### Example 27

A polyester was obtained in a manner similar to that in Example 1 except that loaded monomers were changed to 24.8% by mol of HBA, 72.2% by mol of HNA, 2% by mol of m-hydroxybenzoic acid (C5), and 1% by mol of HQ. Then, the liquid crystal properties of the polyester were confirmed in a manner similar to the above-described manner.

### Example 28

A polyester was obtained in a manner similar to that in Example 1 except that loaded monomers were changed to 24.9% by mol of HBA, 72.6% by mol of HNA, 2% by mol of m-hydroxybenzoic acid (C5), and 0.5% by mol of NADA. Then, the liquid crystal properties of the polyester were confirmed in a manner similar to the above-described manner.

### Example 29

A polyester was obtained in a manner similar to that in Example 1 except that loaded monomers were changed to 24.8% by mol of HBA, 72.2% by mol of HNA, 2% by mol of m-hydroxybenzoic acid (C5), and 1% by mol of TPA. Then, the liquid crystal properties of the polyester were confirmed in a manner similar to the above-described manner.

### Example 30

A polyester was obtained in a manner similar to that in Example 1 except that loaded monomers were changed to 25% by mol of HBA, 72.9% by mol of HNA, 2% by mol of m-hydroxybenzoic acid (C5), and 0.1% by mol of TPA. Then, the liquid crystal properties of the polyester were confirmed in a manner similar to the above-described manner.

### Comparative Example 6

A polyester was obtained in a manner similar to that in Example 1 except that loaded monomers were changed to 21% by mol of HBA, 77% by mol of HNA, and 2% by mol of m-hydroxybenzoic acid (C5). Then, the liquid crystal properties of the polyester were confirmed in a manner similar to the above-described manner.

### <Measurement of Melting Point and Crystallization Point>

The melting points and crystallization points of the liquid crystalline polyesters obtained in Examples and Comparative Examples were measured by a differential scanning calorimeter (DSC) manufactured by Hitachi High-Tech Science Corporation. First, the vertex of an exothermic peak obtained when the temperature of each liquid crystalline polyester was increased from room temperature to 340 to 360° C. at a temperature-raising rate of 10° C./min to completely melt the liquid crystalline polyester, and the temperature was then decreased to 30° C. at a rate of 10° C./min was regarded as the crystallization point (Tc), and the vertex of an endothermic peak obtained when the temperature was further raised to 360° C. at a rate of 10° C./min waws regarded as the melting point (Tm). Moreover, a difference between the melting point and the crystallization point was calculated from the obtained melting point and crystallization point. The melting point (Tm), the crystallization point (Tc), and the difference (Tm−Tc) between the melting point and the crystallization point are set forth in Tables 1 and 2. Each item that was not measured is denoted by “−”.

As is apparent from the results in Tables 1 and 2, the liquid crystalline polyesters of Examples 1 to 30 had low dielectric loss tangents and high melting points, were excellent in heat resistance, had low anisotropies, and were excellent in dimensional stability.

### <Production A of Flat-Plate-Shaped Test Piece>

The liquid crystalline polyesters obtained in Examples and Comparative Examples were heated to melt under a condition of a melting point to the melting point+20° C., and injection-molded to produce flat-plate-shaped test pieces A of 30 mm×30 mm×0.4 mm.

### <Production B of Flat-Plate-Shaped Test Piece>

The liquid crystalline polyesters obtained in Examples and Comparative Examples were heated to melt under a condition of a melting point to the melting point+20° C., and injection-molded to produce flat-plate-shaped test pieces B of 50 mm×50 mm×1 mm.

### <Measurement of Dielectric Loss Tangent (10 GHz)>

With regard to the dielectric loss tangents (tan δ) of the flat-plate-shaped test pieces A produced as described above in an in-plane direction, the dielectric loss tangents at a frequency of 10 GHz were measured by a split post dielectric resonator method (SPDR method) using Network Analyzer N5247A from Keysight Technologies. The measurement results are set forth in Tables 1 and 2. Each item that was not measured is denoted by “−”.

### <Measurement of Anisotropy>

Mold shrinkage rates (%) in the machine direction (MD) of each flat-plate-shaped test piece B produced as described above and the transverse direction (TD) with respect to the machine direction were measured, and a difference between the mold shrinkage rates (mold shrinkage rate in TD−mold shrinkage rate in MD) was calculated to evaluate an anisotropy. The calculation results are set forth in Tables 1 and 2. The lower value of the difference represents a lower anisotropy. Each item that was not measured is denoted by “−”.

### <Measurement of Melt Viscosity>

Melt viscosities (Pa·s) under condition of the melting points of the liquid crystalline polyesters obtained in Examples and Comparative Examples+20° C. and a shear rate of 1000/s were measured according to JIS K7199 using a capillary rheometer viscometer (Capilograph 1D from Toyo Seiki Seisaku-sho, Ltd.) and a capillary having an inner diameter of 1 mm. The measurement results are set forth in Tables 1 and 2.

TABLE 1

| | | | | | | | | | | | | | | | | Performance evaluation | | | | | |
|---|---|---|---|---|---|---|---|---|---|---|---|---|---|---|---|---|---|---|---|---|---|
| | | | | | | | | | | | | | | | | | | | Dielectric | | |
| | Composition (% by mol) | | | | | | | | | | | | | | | | | | loss | | Melt |
| | Constitutional unit | | | | | | | | | | | | | | | | | Tm- | tangent | | vis- |
| | (A) | (B) | (C) | | | | | | | | (D) | | (E) | | | Tm | Tc | Tc | (× 10⁻³) | Aniso- | cosity |
| | HBA | HNA | C1 | C2 | C3 | C4 | C5 | C6 | C7 | C8 | BP | HQ | TPA | IPA | NADA | (° C.) | (° C.) | (° C.) | [10 GHz] | tropy | (Pa · s) |
| Ex. 1 | 25 | 73 | 2 | 0 | 0 | 0 | 0 | 0 | 0 | 0 | 0 | 0 | 0 | 0 | 0 | 320 | 271 | 49 | 0.68 | 0.97 | 83 |
| Ex. 2 | 25 | 73 | 1 | 1 | 0 | 0 | 0 | 0 | 0 | 0 | 0 | 0 | 0 | 0 | 0 | 321 | 272 | 49 | 0.80 | 0.89 | 55 |
| Ex. 3 | 22 | 73 | 5 | 0 | 0 | 0 | 0 | 0 | 0 | 0 | 0 | 0 | 0 | 0 | 0 | 313 | 267 | 46 | 0.65 | 0.84 | 139 |
| Ex. 4 | 25 | 73 | 0 | 0 | 2 | 0 | 0 | 0 | 0 | 0 | 0 | 0 | 0 | 0 | 0 | 324 | 284 | 40 | 0.82 | 0.94 | 66 |
| Ex. 5 | 25 | 73 | 0 | 0 | 0 | 2 | 0 | 0 | 0 | 0 | 0 | 0 | 0 | 0 | 0 | 320 | 273 | 47 | 0.84 | 0.97 | 54 |
| Ex. 6 | 28 | 69 | 2 | 0 | 0 | 0 | 1 | 0 | 0 | 0 | 0 | 0 | 0 | 0 | 0 | 311 | — | — | 0.74 | 0.68 | 139 |
| Ex. 7 | 25 | 73 | 0 | 0 | 0 | 0 | 0 | 2 | 0 | 0 | 0 | 0 | 0 | 0 | 0 | 312 | 269 | 43 | 0.78 | 0.99 | 77 |
| Ex. 8 | 19 | 73 | 8 | 0 | 0 | 0 | 0 | 0 | 0 | 0 | 0 | 0 | 0 | 0 | 0 | 317 | 271 | 46 | 0.71 | 0.77 | 104 |
| Ex. 9 | 26.5 | 73 | 0.5 | 0 | 0 | 0 | 0 | 0 | 0 | 0 | 0 | 0 | 0 | 0 | 0 | 318 | 272 | 46 | 0.84 | 0.92 | 58 |
| Ex. 10 | 25 | 73 | 0 | 0 | 0 | 0 | 0 | 0 | 2 | 0 | 0 | 0 | 0 | 0 | 0 | 325 | 263 | 62 | 0.77 | 0.96 | 66 |
| Ex. 11 | 24.9 | 72.6 | 2 | 0 | 0 | 0 | 0 | 0 | 0 | 0 | 0 | 0 | 0.5 | 0 | 0 | 316 | 264 | 52 | 0.85 | 0.99 | 43 |
| Ex. 12 | 24.9 | 72.6 | 0 | 2 | 0 | 0 | 0 | 0 | 0 | 0 | 0 | 0 | 0.5 | 0 | 0 | 319 | 266 | 53 | 0.82 | 0.98 | 37 |
| Ex. 13 | 25 | 73 | 0 | 0 | 0 | 0 | 2 | 0 | 0 | 0 | 0 | 0 | 0 | 0 | 0 | 318 | 262 | 56 | 0.73 | 0.95 | 66 |
| Ex. 14 | 19 | 73 | 0 | 8 | 0 | 0 | 0 | 0 | 0 | 0 | 0 | 0 | 0 | 0 | 0 | 334 | 266 | 68 | 0.75 | 0.79 | 57 |
| Co. | 73 | 27 | 0 | 0 | 0 | 0 | 0 | 0 | 0 | 0 | 0 | 0 | 0 | 0 | 0 | 278 | 241 | 37 | 1.86 | 0.99 | 31 |
| Ex. 1 | | | | | | | | | | | | | | | | | | | | | |
| Co. | 60 | 0 | 0 | 0 | 0 | 0 | 0 | 0 | 0 | 0 | 20 | 0 | 15 | 5 | 0 | 355 | 310 | 45 | 2.24 | 1.11 | 33 |
| Ex. 2 | | | | | | | | | | | | | | | | | | | | | |
| Co. | 6 | 40 | 0 | 0 | 0 | 0 | 0 | 0 | 0 | 0 | 27 | 0 | 0 | 0 | 27 | 347 | 313 | 34 | 0.88 | 1.05 | 58 |
| Ex. 3 | | | | | | | | | | | | | | | | | | | | | |
| Co. | 35 | 50 | 0 | 0 | 0 | 0 | 0 | 0 | 0 | 15 | 0 | 0 | 0 | 0 | 0 | 247 | 202 | 45 | — | — | 29 |
| Ex. 4 | | | | | | | | | | | | | | | | | | | | | |
| Co. | 20 | 73 | 0 | 0 | 0 | 0 | 7 | 0 | 0 | 0 | 0 | 0 | 0 | 0 | 0 | 298 | 233 | 65 | 1.27 | 0.63 | 4 |
| Ex. 5 | | | | | | | | | | | | | | | | | | | | | |

TABLE 2

| | | | | | | | | | | | | | | | | Performance evaluation | | | | | |
|---|---|---|---|---|---|---|---|---|---|---|---|---|---|---|---|---|---|---|---|---|---|
| | | | | | | | | | | | | | | | | | | | Dielectric | | |
| | Composition (% by mol) | | | | | | | | | | | | | | | | | | loss | | Melt |
| | Constitutional unit | | | | | | | | | | | | | | | | | Tm- | tangent | | vis- |
| | (A) | (B) | (C) | | | | | | | | (D) | | (E) | | | Tm | Tc | Tc | (× 10⁻³) | Aniso- | cosity |
| | HBA | HNA | C1 | C2 | C3 | C4 | C5 | C6 | C7 | C8 | BP | HQ | TPA | IPA | NADA | (° C.) | (° C.) | (° C.) | [10 GHz] | tropy | (Pa · s) |
| Ex. 15 | 28.9 | 68.6 | 0 | 2 | 0 | 0 | 0 | 0 | 0 | 0 | 0 | 0 | 0 | 0.5 | 0 | 308 | 255 | 53 | 0.88 | 0.85 | 64 |
| Ex. 16 | 25.9 | 69.6 | 0 | 4 | 0 | 0 | 0 | 0 | 0 | 0 | 0 | 0 | 0 | 0.5 | 0 | 313 | 258 | 55 | 0.92 | 0.91 | 47 |
| Ex. 17 | 24.9 | 72.6 | 0 | 2 | 0 | 0 | 0 | 0 | 0 | 0 | 0 | 0 | 0 | 0.5 | 0 | 321 | 265 | 56 | 0.77 | 0.88 | 99 |
| Ex. 18 | 24.9 | 72.6 | 0 | 0 | 0 | 0 | 2 | 0 | 0 | 0 | 0 | 0 | 0.5 | 0 | 0 | 311 | 255 | 56 | 0.83 | 0.82 | 44 |
| Ex. 19 | 29.9 | 68.6 | 0 | 0 | 0 | 0 | 1 | 0 | 0 | 0 | 0 | 0 | 0.5 | 0 | 0 | 302 | 250 | 52 | 0.89 | 0.92 | 57 |
| Ex. 20 | 11.9 | 79.6 | 0 | 0 | 0 | 0 | 8 | 0 | 0 | 0 | 0 | 0 | 0.5 | 0 | 0 | 350 | — | — | 0.62 | 0.73 | 69 |
| Ex. 21 | 24.9 | 68.6 | 0 | 0 | 0 | 0 | 6 | 0 | 0 | 0 | 0 | 0 | 0.5 | 0 | 0 | 286 | 221 | 65 | 0.87 | 0.77 | 45 |
| Ex. 22 | 16.9 | 74.6 | 0 | 0 | 0 | 0 | 8 | 0 | 0 | 0 | 0 | 0 | 0.5 | 0 | 0 | 320 | 243 | 77 | 0.66 | 0.68 | 57 |
| Ex. 23 | 19.9 | 74.6 | 0 | 0 | 0 | 0 | 5 | 0 | 0 | 0 | 0 | 0 | 0.5 | 0 | 0 | 316 | 251 | 65 | 0.72 | 0.90 | 45 |
| Ex. 24 | 22.9 | 71.6 | 0 | 0 | 0 | 0 | 5 | 0 | 0 | 0 | 0 | 0 | 0.5 | 0 | 0 | 307 | 242 | 65 | 0.86 | 0.87 | 49 |
| Ex. 25 | 34 | 65 | 0 | 0 | 0 | 0 | 1 | 0 | 0 | 0 | 0 | 0 | 0 | 0 | 0 | 289 | 247 | 42 | 0.98 | 1.00 | 33 |
| Ex. 26 | 24.9 | 72.6 | 0 | 0 | 0 | 0 | 2 | 0 | 0 | 0 | 0.5 | 0 | 0 | 0 | 0 | 320 | 272 | 48 | 0.63 | 0.79 | 52 |
| Ex, 27 | 24.8 | 72.2 | 0 | 0 | 0 | 0 | 2 | 0 | 0 | 0 | 0 | 1 | 0 | 0 | 0 | 319 | — | — | 0.60 | 0.84 | 44 |
| Ex. 28 | 24.9 | 72.6 | 0 | 0 | 0 | 0 | 2 | 0 | 0 | 0 | 0 | 0 | 0 | 0 | 0.5 | 314 | 270 | 44 | 0.86 | 1.00 | 42 |
| Ex. 29 | 24.8 | 72.2 | 0 | 0 | 0 | 0 | 2 | 0 | 0 | 0 | 0 | 0 | 1 | 0 | 0 | 308 | 262 | 46 | 0.83 | 0.73 | 37 |
| Ex. 30 | 25 | 72.9 | 0 | 0 | 0 | 0 | 2 | 0 | 0 | 0 | 0 | 0 | 0.1 | 0 | 0 | 316 | — | — | 0.79 | 0.74 | 166 |
| Co. | 21 | 77 | 0 | 0 | 0 | 0 | 2 | 0 | 0 | 0 | 0 | 0 | 0 | 0 | 0 | 328 | 289 | 39 | 0.99 | 1.05 | 21 |
| Ex. 6 | | | | | | | | | | | | | | | | | | | | | |

1. A liquid crystalline polyester comprising 90% by mol or more of a constitutional unit derived from an aromatic hydoxycarboxylic acid with respect to an amount of all constitutional units, wherein
a dielectric loss tangent at a measurement frequency of 10 GHz is 1.0×10⁻³ or less,
a difference (anisotropy) between mold shrinkage rates in a machine direction (MD) of an injection-molded piece of the liquid crystalline polyester and a transverse direction (TD) with respect to the machine direction is 1.00 or less, and
a melt viscosity measured under conditions of a shear rate of 1000/s and a melting point of the liquid crystalline polyester to the melting point+20° C. is 25 Pas or more.

2. A liquid crystalline polyester comprising 90% by mol or more of a constitutional unit derived from an aromatic hydoxycarboxylic acid with respect to an amount of all constitutional units, wherein
the liquid crystalline polyester comprises a constitutional unit (A) derived from p-hydroxybenzoic acid, a constitutional unit (B) derived from 6-hydroxy-2-naphthoic acid, and a constitutional united (C) derived from a hydroxycarboxylic acid, other than the constitutional units (A) and (B), and
composition ratios (% by mol) of the constitutional units (A) to (C) satisfy following conditions:
10% by mol≤constitutional unit (A)≤35% by mol,
50% by mol≤constitutional unit (B)≤85% by mol, and
0.01% by mol≤constitutional unit (C)<15% by mol.

3. The liquid crystalline polyester according to claim 2, wherein the constitutional unit (C) is a constitutional unit derived from at least one selected from a group consisting of 4′-hydroxy-4-biphenylcarboxylic acid, 6-hydroxynicotinic acid, m-hydroxybenzoic acid, 4-hydroxy-3-methylbenzoic acid, 2-fluoro-4-hydroxybenzoic acid, 4-acetamidebenzoic acid, 4-(4-hydroxyphenoxy)benzoic acid, and coumaric acid.

4. The liquid crystalline polyester according to claim 2, wherein the constitutional unit (C) is a constitutional unit derived from at least one selected from a group consisting of 4′-hydroxy-4-biphenylcarboxylic acid, 6-hydroxynicotinic acid, and m-hydroxybenzoic acid.

5. The liquid crystalline polyester according to any claim 2, further comprising at least one selected from a group consisting of a constitutional unit (D) derived from an aromatic diol and a constitutional unit (E) derived from an aromatic dicarboxylic acid.

6. The liquid crystalline polyester according to claim 1, wherein the liquid crystalline polyester has a melting point of 280° C. or more.

7. The liquid crystalline polyester according to claim 6, wherein a temperature difference between a melting point and a crystallization point is 30° C. or more.

8. A fibrous molded article comprising the liquid crystalline polyester according to claim 1.

9. A sheet-like molded article comprising the liquid crystalline polyester according to claim 1.

10. An injection-molded article comprising the liquid crystalline polyester according to claim 1.

11. An electric/electronic component comprising the molded article according to claim 8.

12. An electric/electronic component comprising the molded article according to claim 9.

13. An electric/electronic component comprising the molded article according to claim 10.

14. The liquid crystalline polyester according to claim 2, wherein the liquid crystalline polyester has a melting point of 280° C. or more.

15. The liquid crystalline polyester according to claim 14, wherein a temperature difference between a melting point and a crystallization point is 30° C. or more.

16. A fibrous molded article comprising the liquid crystalline polyester according to claim 2.

17. A sheet-like molded article comprising the liquid crystalline polyester according to claim 2.

18. An injection-molded article comprising the liquid crystalline polyester according to claim 2.

19. An electric/electronic component comprising the molded article according to claim 16.

20. An electric/electronic component comprising the molded article according to claim 17.
